(19) United States
(12) Patent Application Publication
(10) Pub. No.: US 2015/0225013 A1
(43) Pub. Date: Aug. 13, 2015

(54) DRIVE SYSTEM, DRIVE UNIT, CONTROL DEVICE AND CONTROL METHOD

(71) Applicant: Toyota Jidosha Kabushiki Kaisha, Toyota-shi (JP)

(72) Inventor: Kenji Tamura, Nissin-shi (JP)

(21) Appl. No.: 14/616,993

(22) Filed: Feb. 9, 2015

(30) Foreign Application Priority Data
Feb. 13, 2014 (JP) 2014-025887

(51) Int. Cl. B62D 5/04; H02P 29/02

(52) U.S. Cl. CPC B62D 5/0484; B62D 5/0487; H02P 29/022

(57) ABSTRACT

A drive system includes: an inverter circuit including switching circuits for multiple phases, each of the switching circuits including an upper arm and a lower arm connected in series, and each of the upper and lower arms including multiple switching devices connected in parallel; a motor driven by the inverter circuit to generate steering torque; and a control device configured to control the inverter circuit. When detecting a fault in at least one of the multiple switching devices connected in parallel in any of the arms during use of a vehicle, the control device drives the remainder of the multiple switching devices in the arm where the fault is detected, until the vehicle is brought to a prescribed vehicle non-use state. The control device restricts driving of the remainder of the multiple switching devices when the vehicle is brought to a vehicle use state from the prescribed vehicle non-use state.

### INCORPORATION BY REFERENCE

The disclosure of Japanese Patent Application No. 2014-025887 filed on Feb. 13, 2014 including the specification, drawings and abstract is incorporated herein by reference in its entirety.

### BACKGROUND OF THE INVENTION

1. Field of the Invention

The present invention relates to a drive system, a drive unit, a control device and a control method.

2. Description of Related Art

There is a known electric power steering system in which switching means is connected in series with each phase coil and the switching means is turned off when an abnormality occurs in a switching device for the corresponding phase (refer to, for example, Japanese Patent Application Publication No. 2007-099066 (JP 2007-099066 A). In the electric power steering system, a motor drive circuit has a configuration in which three series circuits for respective three phases are connected in parallel, and each of the series circuits includes two switching devices connected in series. When an abnormality is detected in any one of the switching devices that constitute the motor drive circuit, the switching means interposed between the switching device having the abnormality and the corresponding phase coil is turned off, and electric currents to be supplied to the remaining two phase coils connected to the switching devices having no abnormality are controlled such that the magnetic field vector rotates.

However, according to the technique described in JP 2007-099066 A, when an abnormality is detected in a switching device for one of the three phases, steering assist force is generated by using the remaining two phase coils. This may cause a change in the steering feel.

### SUMMARY OF THE INVENTION

The present invention provides a drive system, a drive unit, a control device and a control method that make it possible to reduce a change in the steering torque due to a fault caused in a switching device during the use of a vehicle.

A first aspect of the invention relates to a drive system including: an inverter circuit including switching circuits for multiple phases, each of the switching circuits including an upper arm and a lower arm connected in series, and each of the upper arm and the lower arm including multiple switching devices connected in parallel; a motor driven by the inverter circuit to generate steering torque; and a control device configured to control the inverter circuit. When detecting a fault in at least one of the multiple switching devices connected in parallel in any of the arms during use of a vehicle, the control device drives the remainder of the multiple switching devices in the arm in which the fault is detected, until the vehicle is brought to a prescribed vehicle non-use state. The control device restricts driving of the remainder of the multiple switching devices when the vehicle is brought to a vehicle use state from the prescribed vehicle non-use state.

A second aspect of the invention relates to a control device configured to drive an inverter circuit including switching circuits for multiple phases, each of the switching circuits including an upper arm and a lower arm connected in series, and each of the upper arm and the lower arm including multiple switching devices connected in parallel. The control device includes: a fault determining unit configured to detect whether there is a fault in at least one of the multiple switching devices connected in parallel in any of the arms when a vehicle is in a use state; and a drive control unit. When a fault is detected in at least one of the switching devices by the fault determining unit, the drive control unit drives the remainder of the multiple switching devices in the arm in which the fault is detected, until the vehicle is brought to a prescribed vehicle non-use state. The drive control unit is configured to restrict driving of the remainder of the multiple switching devices when the vehicle is brought to a vehicle use state from the prescribed vehicle non-use state.

A third aspect of the invention relates to a control method of driving an inverter circuit disposed in a vehicle, the inverter circuit including switching circuits for multiple phases, each of the switching circuits including an upper arm and a lower arm connected in series, and each of the upper arm and the lower arm including multiple switching devices connected in parallel. The control method includes: detecting whether there is a fault in at least one of the multiple switching devices connected in parallel in any of the arms during use of a vehicle; driving, when detecting a fault in at least one of the multiple switching devices, the remainder of the multiple switching devices in the arm in which the fault is detected, until the vehicle is brought to a prescribed vehicle non-use state; and restricting driving of the remainder of the multiple switching devices when the vehicle is brought to a vehicle use state from the prescribed vehicle non-use state.

A fourth aspect of the invention relates to a drive unit including: an inverter circuit including switching circuits for multiple phases, each of the switching circuits including an upper arm and a lower arm connected in series, and each of the upper arm and the lower arm including multiple switching devices connected in parallel; and a control device configured to control the inverter circuit. When detecting a fault in at least one of the multiple switching devices connected in parallel in any of the arms during use of a vehicle, the control device drives the remainder of the multiple switching devices in the arm in which the fault is detected, until the vehicle is brought to a prescribed vehicle non-use state. The control device restricts driving of the remainder of the multiple switching devices when the vehicle is brought to a vehicle use state from the prescribed vehicle non-use state.

According to the above-described aspects of the invention, it is possible to reduce a change in the steering torque due to a fault caused in a switching device during the use of a vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration diagram illustrating an example of a drive unit and an example of a motor drive system;

FIG. 2 is a flowchart illustrating an example of a one-side open fault detecting method for an inverter circuit; and

FIG. 3 is a flowchart illustrating an example of a process executed by a drive control unit.

### DETAILED DESCRIPTION OF EMBODIMENTS

Hereinafter, example embodiments of the invention will be described in detail with reference to the accompanying drawings.

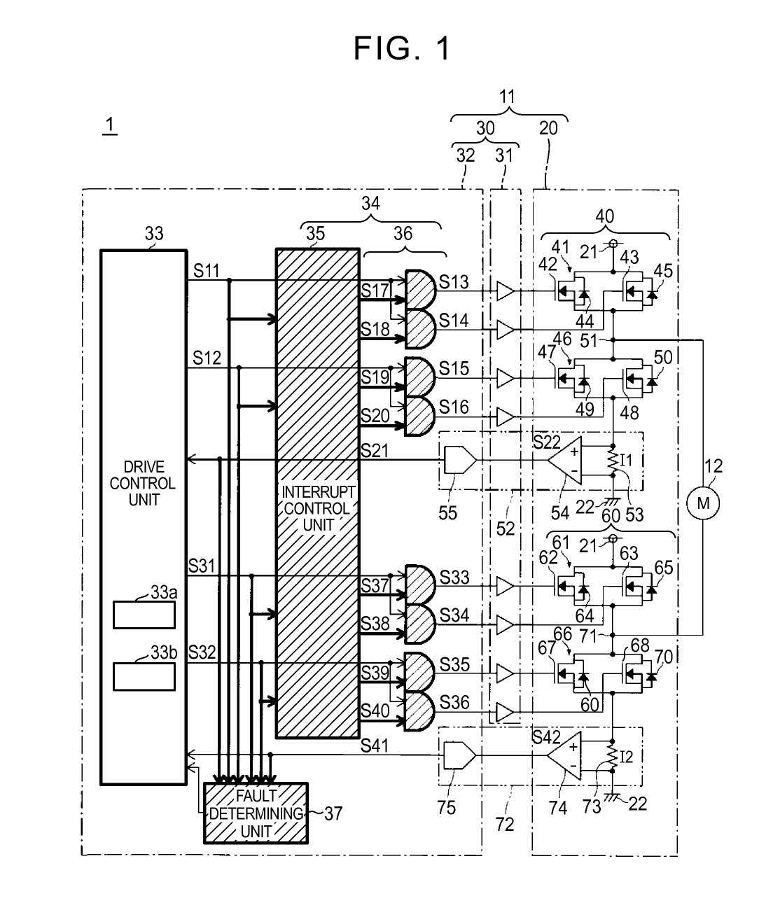

FIG. 1 is a configuration diagram illustrating an example of a drive unit 11 and an example of a motor drive system 1. The motor drive system 1 is an example of a system installed in a vehicle. The motor drive system 1 includes the drive unit 11, and a motor 12 that is driven by the drive unit 11.

The motor 12 is an example of an inductive load that is driven by an electric current supplied from an inverter circuit 20 of the drive unit 11. The motor 12 is, for example, a three-phase (U-phase, V-phase, W-phase) brushless motor. Alternatively, the motor 12 may be a multi-phase motor other than a three-phase motor. For example, the motor 12 may be a five-phase motor.

Note that, in the inverter circuit 20 illustrated in FIG. 1, only switching circuits 40, 60 for two phases are illustrated and the illustration of a switching circuit for the remaining one phase is omitted, for convenience of description. When the motor driven by the inverter circuit 20 is a three-phase motor, the inverter circuit 20 includes three switching circuits. When the motor driven by the inverter circuit 20 is a five-phase motor, the inverter circuit 20 includes five switching circuits. In other words, the number of switching circuits of the inverter circuit 20 is equal to the number of the phases of the motor driven by the inverter circuit 20.

Specific examples of the motor drive system 1 include an electric power steering system that assists a driver in performing a steering operation. In this case, the motor 12 is an example of an actuator that is driven, for example, by the inverter circuit 20 of the drive unit 11 to generate assisting force (steering torque) for assisting a driver in performing a steering operation.

The drive unit 11 includes the inverter circuit 20 and a control device 30.

The inverter circuit 20 is an example of an inverter circuit including switching circuits for multiple phases. Each switching circuit is formed by connecting an upper arm and a lower arm in series. The inverter circuit 20 has a circuit configuration in which multiple switching circuits having the same configuration are connected in parallel. The inverter circuit 20 includes, for example, the switching circuit 40 for the U-phase, the switching circuit 60 for the V-phase, and a switching circuit (not illustrated) for the W-phase.

The switching circuit 40 is an example of a switching circuit formed by connecting an upper arm 41 and a lower arm 46 in series between a high power supply potential section 21 and a low power supply potential section 22. The upper arm 41 is a switching device group disposed on the high potential side, that is, the high power supply potential section 21 side, with respect to an intermediate node 51, whereas the lower arm 46 is a switching device group disposed on the low potential side, that is, the low power supply potential section 22 side, with respect to the intermediate node 51. The intermediate node 51 is connected to, for example, a U-phase coil of the motor 12.

The high power supply potential section 21 is a section that is connected in a conductive manner to, for example, a positive electrode terminal of a power supply such as a battery or a converter. The low power supply potential section 22, which is lower in potential than the high power supply potential section 21, is a ground section that is connected in a conductive manner to, for example, a negative electrode terminal of the power supply such as a battery or a converter, or to a vehicle body grounding section.

In the switching circuit 40, each of the upper arm 41 and the lower arm 46 includes a plurality of switching devices connected in parallel. In the example illustrated in FIG. 1, the upper arm 41 includes two transistors connected in parallel, that is, a transistor 42 and a transistor 43, and the lower arm 46 includes two transistors connected in parallel, that is, a transistor 47 and a transistor 48.

The switching circuit 60 is an example of a switching circuit formed by connecting an upper arm 61 and a lower arm 66 in series between a high power supply potential section 21 and a low power supply potential section 22. The upper arm 61 is a switching device group disposed on the high potential side, that is, the high power supply potential section 21 side, with respect to an intermediate node 71, whereas the lower arm 66 is a switching device group disposed on the low potential side, that is, the low power supply potential section 22 side, with respect to the intermediate node 71. The intermediate node 71 is connected to, for example, a V-phase coil of the motor 12.

In the switching circuit 60, each of the upper arm 61 and the lower arm 66 includes a plurality of switching devices connected in parallel. In the example illustrated in FIG. 1, the upper arm 61 includes two transistors connected in parallel, that is, a transistor 62 and a transistor 63, and the lower arm 66 includes two transistors connected in parallel, that is, a transistor 67 and a transistor 68.

Each of the transistors is an example of a switching device that is turned on and off. Each of the transistors is, for example, an insulated gate voltage-controllable semiconductor device including a control electrode, a first main electrode, and a second main electrode. Specific examples of the transistor include power transistor devices such as a metal-oxide semiconductor field-effect transistor (MOSFET) and an insulated gate bipolar transistor (IGBT). FIG. 1 illustrates N-channel MOSFETs.

The following description will be provided on the assumption that the transistors are MOSFETs, for convenience of description. In the case where the transistors are IGBTs, “drain” and “source” in the following description should be replaced with “collector” and “emitter,” respectively.

The gate electrode of the transistor 42 is an example of the control electrode that is connected to an inverter drive circuit 31 of the control device 30. The drain electrode of the transistor 42 is an example of the first main electrode that is connected to the high power supply potential section 21. The source electrode of the transistor 42 is an example of the second main electrode that is connected to the low power supply potential section 22 via the intermediate node 51 and the lower arm 46. The same applies to the transistor 43.

The gate electrodes of the transistors 42, 43 are connected to the inverter drive circuit 31, and are connected respectively to different pre-drivers. The drain electrodes of the transistors 42, 43 are connected to each other, and the source electrodes of the transistors 42, 43 are also connected to each other.

The gate electrode of the transistor 47 is an example of the control electrode that is connected to the inverter drive circuit 31 of the control device 30. The drain electrode of the transistor 47 is an example of the first main electrode that is connected to the high power supply potential section 21 via the intermediate node 51 and the upper arm 41. The source electrode of the transistor 47 is an example of the second main electrode that is connected to the low power supply potential section 22. The same applies to the transistor 48.

The gate electrodes of the transistors 47, 48 are connected to the inverter drive circuit 31, and are connected respectively to different pre-drivers. The drain electrodes of the transistors 47, 48 are connected to each other, and the source electrodes of the transistors 47, 48 are also connected to each other.

The transistor 42 includes a diode 44 used for reverse conduction, between the drain electrode and the source electrode. The diode 44 is a device that is in reverse conducting connection to the transistor 42. The diode 44 has a cathode that is connected to the drain electrode of the transistor 42, and an anode that is connected to the source electrode of the transistor 42. The same applies to diodes 45, 49, 50.

The configuration of the switching circuit 60 is the same as that of the switching circuit 40. Therefore, the description of the switching circuit 60 will be omitted by referring to the description of the switching circuit 40.

The control device 30 includes the inverter drive circuit 31 and a control circuit 32.

The inverter drive circuit 31 includes a plurality of pre-drivers that output control signals for turning on or off the transistors of the inverter circuit 20, to the control electrodes of the transistors, in response to command signals from the control circuit 32. The pre-drivers of the inverter drive circuit 31 output control signals for turning on or off the transistors of the inverter circuit 20 in synchronization with the command signals from the control circuit 32 such that three-phase alternating-current (AC) power for driving the motor 12 is supplied from the inverter circuit 20 to the motor 12. The pre-drivers are, for example, integrated circuits (ICs).

The inverter drive circuit 31 turns on or off the upper arm 41 of the switching circuit 40 in response to command signals S13, S14 from the control circuit 32, and turns on or off the lower arm 46 of the switching circuit 40 in response to command signals S15, S16 from the control circuit 32. The inverter drive circuit 31 turns on or off the upper arm 61 of the switching circuit 60 in response to command signals S33, S34 from the control circuit 32, and turns on or off the lower arm 66 of the switching circuit 60 in response to command signals S35, S36 from the control circuit 32.

The drive unit 11 includes a detecting circuit 52 and a detecting circuit 72. The detecting circuit 52 detects a phase current I1 flowing through the lower arm 46 disposed between the low power supply potential section 22 and the intermediate node 51. The detecting circuit 72 detects a phase current I2 flowing through the lower arm 66 disposed between the low power supply potential section 22 and the intermediate node 71. The detecting circuit 52 outputs a feedback signal S21 corresponding to a current value of the phase current I1 flowing through the lower arm 46. The detecting circuit 72 outputs a feedback signal S41 corresponding to a current value of the phase current I2 flowing through the lower arm 66. In FIG. 1 illustrates an example of the detecting circuit 52 and an example of the detecting circuit 72.

The detecting circuit 52 includes, for example, a shunt resistance 53, a differential amplifier 54, and an analog-digital (AD) converter 55. The shunt resistance 53 is inserted in series between the lower arm 46 and the low power supply potential section 22, and generates a detection voltage corresponding to the current value of the phase current I1. The differential amplifier 54 outputs an analog voltage S22 that is obtained by subjecting the detection voltage generated by the shunt resistance 53 to differential amplification. The AD converter 55 subjects the analog voltage S22 to analog-digital (AD) conversion, and outputs the digital feedback signal S21.

The detecting circuit 72 includes, for example, a shunt resistance 73, a differential amplifier 74, and an analog-digital (AD) converter 75. The shunt resistance 73 is inserted in series between the lower arm 66 and the low power supply potential section 22, and generates a detection voltage corresponding to the current value of the phase current I2. The differential amplifier 54 outputs an analog voltage S42 that is obtained by subjecting the detection voltage generated by the shunt resistance 73 to differential amplification. The AD converter 75 subjects the analog voltage S42 to analog-digital (AD) conversion, and outputs the digital feedback signal S41.

The control circuit 32 includes a drive control unit 33, an interrupting unit 34, and a fault determining unit 37. Specific examples of the control circuit 32 include a microcomputer provided with a central processing unit (CPU). The AD converters 55, 75 may be circuits incorporated in the microcomputer, or external circuits attached to the microcomputer.

The drive control unit 33 executes feedback control of outputting pulse width modulation (PWM) signals for driving the arms under PWM control based on the feedback signals for the phase currents flowing through the lower arms of the switching circuits, and target values of the phase currents. The drive control unit 33 outputs PWM signals S11, S12, S31, S32. The PWM signal S11 is a signal for turning on or off the upper arm 41 of the switching circuit 40. The PWM signal S12 is a signal for turning on or off the lower arm 46 of the switching circuit 40. The PWM signal S31 is a signal for turning on or off the upper arm 61 of the switching circuit 60. The PWM signal S32 is a signal for turning on or off the lower arm 66 of the switching circuit 60.

The drive control unit 33 includes a non-volatile memory 33a and a volatile memory 33b.

The interrupting unit 34 executes interrupt control. In the interrupt control, while an arm is driven under pulse width modulation (PWM) control (hereinafter, driving under PWM control will be sometimes referred to as “PWM driving”), the interrupting unit 34 provides the inverter drive circuit 31 with an interrupt for temporarily prohibiting one of the transistors in the arm from being driven under PWM control, thereby allowing only the remaining one of the transistors in the arm to be driven under PWM control. The interrupting unit 34 includes an interrupt control unit 35 that executes the interrupt control on each of the transistors using an AND gate 36.

The fault determining unit 37 executes control of determining whether each of the transistors has an open fault. Note that, an open fault means that a transistor is stuck in an off-state (open state) and electric conduction is kept interrupted. In the control, the fault determining unit 37 compares expectation values of phase currents of the respective phases, which are determined based on the states of the PWM signals output from the drive control unit 33, with detected values of phase currents of the respective phases, which are obtained based on the feedback signals S21, S41, thereby determining whether each of the transistors has an open fault. When determining that any one of the transistors has an open fault, the fault determining unit 37 outputs, for example, abnormality information on the transistor determined to have an open fault (e.g., diagnostic information or warning information for notifying a user of the occurrence of the open fault).

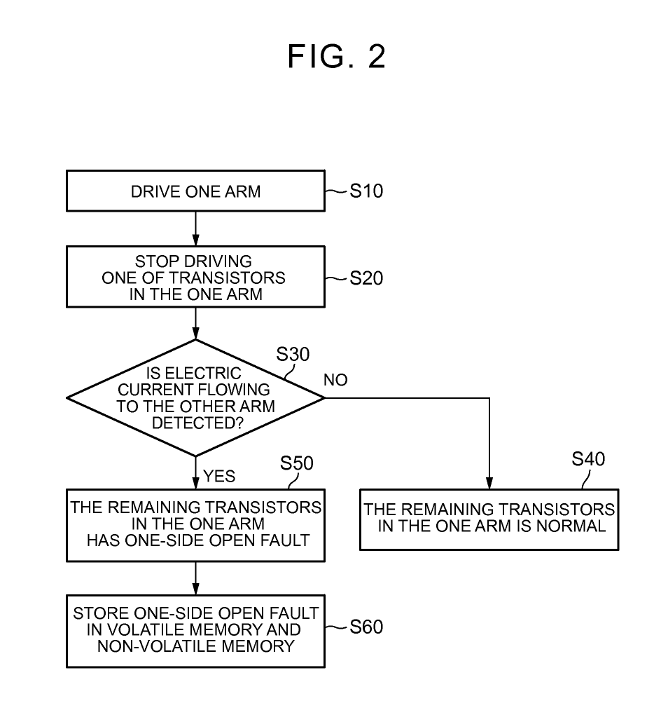

FIG. 2 is a flowchart illustrating an example of a one-side open fault detecting method for the inverter circuit 20. The one-side open fault detecting method illustrated in FIG. 2 is executed on each of the transistors in the inverter circuit 20 by the control circuit 32 (the drive control unit 33, the interrupting unit 34, and the fault determining unit 37). FIG. 2 will be described below with reference to FIG. 1. The process illustrated in FIG. 2 may be executed at any given timing (e.g., multiple times) while an ignition switch is on.

When any one of the upper arm and the lower arm is being driven under PWM control by the drive control unit 33 (step S10), the interrupting unit 34 temporarily stops PWM driving of one of the transistors in the one arm being driven under PWM control (step S20). That is, in step S20, the interrupting unit 34 continues PWM driving of the other transistor connected in parallel to the one transistor that is temporarily stopped (prohibited) from being driven under PWM control, instead of temporarily stopping (prohibiting) PWM driving of the other transistor. The one transistor and the other transistor are both included in the multiple transistors disposed in the one arm being driven under PWM control.

In the following description, the one transistor that is temporarily stopped from being driven under PWM control will be denoted by “transistor A,” and the other transistor connected in parallel to the one transistor, which is temporarily stopped from being driven under PWM control, will be denoted by “transistor B.” In addition, the other arm in the switching circuit for the same phase as the one arm including the transistor A (in other words, the arm that faces the one arm) will be denoted by “arm C.” Further, the period during which the transistor A is temporarily stopped from being driven under PWM control will be denoted by “period X.”

In FIG. 1, for example, if the transistor A is the transistor 42, the transistor B corresponds to the transistor 43 and the arm C corresponds to the lower arm 46. For example, if the transistor A is the transistor 68, the transistor B corresponds to the transistor 67 and the arm C corresponds to the upper arm 61.

In a normal state where the transistor B has no open fault, when a control signal for driving the transistor B under PWM control is input into the control electrode of the transistor B in the period X, the transistor B is turned on in the period X. Thus, in the period X, the transistor B is turned on while the transistor A is off. Thus, a phase current, circulated in the period X, flows to the transistor B but flows to neither the transistor A nor the arm C.

On the other hand, in an abnormal state where the transistor B has an open fault, the transistor B is not turned on even when a control signal for driving the transistor B under PWM control is input into the control electrode of the transistor B in the period X. Thus, neither the transistor A nor the transistor B is turned on (because both the transistor A and the transistor B are off) in the period X, the phase current circulated in the period X does not flow to the transistors A, B but flows to the arm C.

Therefore, in step S30, the fault determining unit 37 determines whether or not the phase current circulated in the period X flows to the other arm that faces the one arm being driven under PWM control, that is, flows to the arm C. When detecting the fact that the phase current circulated in the period X flows to the arm C, the fault determining unit 37 determines that the transistor among the multiple transistors in the one arm, other than the transistor A, has an open fault, that is the transistor B has an open fault (step S50). Hereafter, such a fault mode will be referred to as “one-side open fault.” On the other hand, when detecting the fact that the phase current circulated in the period X does not flow to the arm C, the fault determining unit 37 determines that the transistor B has no open fault (step S40).

In step S50, the information indicating that a one-side open fault is detected is stored in the volatile memory 33b and the non-volatile memory 33a. Note that storage of the information may be executed by setting a flag. The information may be stored together with the information for identifying the arm in which the one-side open fault is detected (or the information for identifying the transistor having the open fault). Once a one-side open fault is detected in an arm, the process in FIG. 2 need not be executed on the arm in the trip (i.e., until the ignition switch is turned off). Alternatively, once a one-side open fault is detected, the process in FIG. 2 need not be executed on the arm or the transistor having the one-side open fault in the subsequent trips as long as the information indicating the one-side open fault is stored in the non-volatile memory 33a. When a one-side open fault is detected, a warning may be output to, for example, a meter to notify a driver of the one-side open fault.

Note that, the method of detecting a one-side open fault illustrated in FIG. 2 is just an example, and another detecting method may be adopted. It should be understood that the method of detecting an one-side open fault illustrated in FIG. 2 can be implemented with a program that is executed by the control circuit 32, without additionally providing a special element such as a temperature detecting sensor, and it is thus possible to simplify the configuration for detecting an open fault of each of the transistors that are connected in parallel.

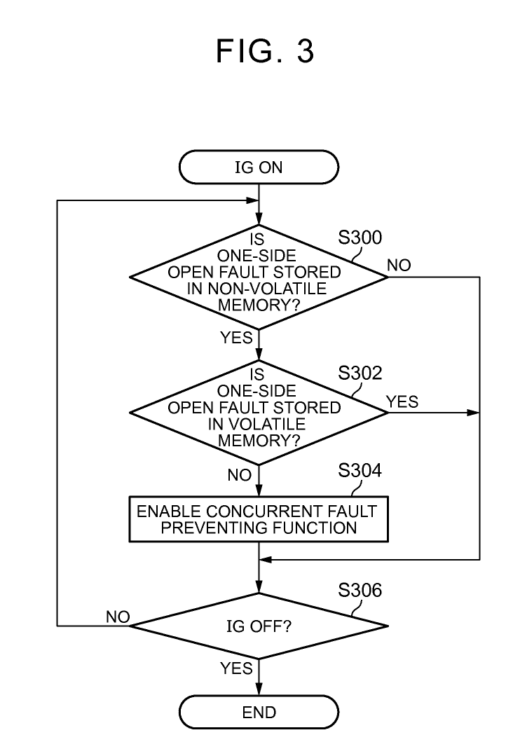

FIG. 3 is a flowchart illustrating an example of a process executed by the drive control unit 33. The process illustrated in FIG. 3 is repeatedly executed on a prescribed cycle while the ignition switch is on. That is, the process from step S300 to step S304 is repeatedly executed on the prescribed cycle until the ignition switch is turned off (YES in step S306).

In step S300, the drive control unit 33 determines whether or not the information indicating detection of a one-side open fault is stored in the non-volatile memory 33a. Note that such information may be stored through the process illustrated in FIG. 2 (refer to S60). Note that such information is not basically deleted once stored in the non-volatile memory 33a, but is deleted when the one-side open fault is eliminated by, for example, a dealer. When the information indicating detection of a one-side open fault is stored in the non-volatile memory 33a, the drive control unit 33 proceeds on to step S302. Otherwise, the drive control unit 33 proceeds on to step S306.

In step 302, the drive control unit 33 determines whether or not information indicating detection of a one-side open fault is stored in the volatile memory 33b. Note that such information may be stored through the process illustrated in FIG. 2 (refer to S60). It should be understood that, in the case of the volatile memory 33b, such information is deleted when the ignition switch is turned off, and thus the fact that such information is stored in the volatile memory 33b means that a one-side open fault is detected after the ignition switch is turned on this time. If the information is stored in the volatile memory 33b, the information is deleted when the ignition switch is turned off. Therefore, if such information indicating detection of a one-side open fault is stored in the volatile memory 33b, the drive control unit 33 proceeds on to step S306. Otherwise, the drive control unit 33 proceeds on to step S304.

In step S304, the concurrent fault preventing function is enabled. When the concurrent fault preventing function has already been in an on-state, the on-state is maintained. When the concurrent fault preventing function is enabled, driving of the arm in which a one-side open fault is detected is restricted. Although driving of the arm in which the one-side open fault is detected can be continued because the arm has a transistor having no fault, driving of the transistor having no fault is restricted. Examples of the restricting method may include a method of restricting driving of a transistor having no fault, and a method of stopping driving of all the transistors for the same phase as that of the arm in which the one-side open fault is detected, so that a phase current in the arm in which the one-side open fault is detected does not exceed a prescribed upper limit value (e.g., half the maximum value of a range of the phase currents, which may be achieved in normal times, that is, when no fault is detected). When driving of all the transistors for the same phase as that of the arm, in which the one-side open fault is detected, is stopped, the transistors for the other phases (in this embodiment, the other two phases) are driven.

The configuration as illustrated in FIG. 1, in which the transistors 42, 43 (the transistors 47, 48) are connected in parallel has an advantage that a larger motor current can be supplied to the motor 12 accordingly. However, in the case where one of the transistors 42, 43 connected in parallel has a fault, if the transistors 42, 43 are driven in the same manner as that when the transistors 42, 43 have no fault, a resistance loss (calorific value) of the other transistor increases. Thus, a fault (concurrent fault) is more likely to occur in the other transistor.

In this regard, according to the process illustrated in FIG. 3, when a one-side open fault is detected, the concurrent fault preventing function is enabled from the time when the ignition switch is turned on next time. Thus, the possibility of occurrence of a concurrent fault is reduced. That is, when the concurrent fault preventing function is enabled, driving of the transistor having no fault is restricted as described above. Thus, it is possible to reduce the possibility of occurrence of a concurrent fault (in particular, a concurrent fault in the other transistor that is connected in parallel to the transistor in which the fault is detected).

However, when the concurrent fault preventing function is enabled, driving of the transistor having no fault is restricted as described above. This causes a change in the assisting force. Such a change may give a driver a sense of discomfort.

In this regard, according to the process illustrated in FIG. 3, even when a one-side open fault is detected while the ignition switch is on, that is, while the vehicle is used, the concurrent fault preventing function is not immediately enabled. Instead, the concurrent fault preventing function is enabled when the ignition switch is turned on after the ignition switch is once turned off (after the vehicle is once brought to a non-use state). That is, the concurrent fault preventing function is enabled on the condition that the vehicle is once brought to the non-use state after the one-side open fault is detected. This prevents a disadvantage (i.e., giving a driver a sense of discomfort) which would be caused by enabling the concurrent fault preventing function.

According to the process illustrated in FIG. 3, by enabling the concurrent fault preventing function at appropriate timing (at the time when the use of the vehicle is started after the vehicle is once brought to the non-use state) when a one-side open fault is detected, it is possible to reduce the possibility of occurrence of a concurrent fault, and, in addition, it is possible to prevent a driver from feeling a sense of discomfort. When the vehicle is used after the vehicle is once brought to the non-use state, the concurrent fault preventing function is enabled as described above and thus the assisting force differs from that when the vehicle is used last time. However, when the vehicle is used after the vehicle is once brought to the non-use state, a change in the assisting force is noticed by a driver while the vehicle is traveling at a low speed. Therefore, when the vehicle is used after the vehicle is once brought to the non-use state, the driver is able to deal with a change in the assisting force more calmly than when the concurrent fault preventing function is enabled during the use of the vehicle (e.g., when the vehicle is traveling at a middle or high speed). This improves the safety.

The process illustrated in FIG. 3 is repeatedly executed on the prescribed cycle while the ignition switch is on. Alternatively, the process illustrated in FIG. 3 may be executed only once at the time of turning on the ignition switch (i.e., at the time of starting the use of the vehicle). In this case, the process in step 302 is no longer necessary, and the volatile memory 33b itself is no longer necessary.

While the invention has been described with reference to an example embodiment thereof, it is to be understood that the invention is not limited to a specific embodiment. To the contrary, the invention is intended to cover various modifications and changes within the scope of the appended claims. In addition, all or some of the elements in the above-described embodiment may be combined with each other.

For example, in the above-described embodiment, “during the use of the vehicle” corresponds to “during the on-state of the ignition switch”. However, in the case of an electric vehicle, “during the use of the vehicle” may correspond to “during the on-state of a vehicle power supply”. In addition, in the above-described embodiment, the vehicle non-use state corresponds to a state where the ignition switch is off. However, in the case of an electric vehicle, the vehicle non-use state may correspond to the off-state of a vehicle power supply.

In the above-described embodiment, with regard to the vehicle non-use state, which is used as a condition for enabling the concurrent fault preventing function, the off time of the ignition switch (i.e., the soak time) is not taken into account. However, the off time of the ignition switch may be taken into account. For example, the concurrent fault preventing function may be enabled when the off time of the ignition switch after a one-side open fault is detected is equal to or longer than a prescribed duration of time.

In the above-described embodiment, with regard to the vehicle non-use state, which is used as a condition for enabling the concurrent fault preventing function, the engine stopped state established by idle reduction control is not taken into account. However, the engine stopped state established by idle reduction control may be taken into account. That is, the concurrent fault preventing function may be enabled when the engine stopping state due to the idle reduction control is established after a one-side open fault is detected.

In the above-described embodiment, MOSFETs or IGBTs are used as the switching devices. However, the switching devices may be bipolar transistors.

In the above-described embodiment, the number of switching devices connected in parallel is two. However, the number of switching devices connected in parallel may be three or more. For example, in the case of an arm including three transistors connected in parallel, when detecting the fact that an electric current circulated in the period X, during which driving of one transistor A is stopped, flows to the arm C, the control circuit 32 determines that the remaining two transistors B connected to the one transistor A have an open fault. For example, in the case of an arm including three transistors connected in parallel, when detecting the fact that an electric current circulated in the period X, during which driving of two transistors A is stopped, flows to the arm C, the control circuit 32 determines that the remaining one transistor B connected to the two transistors A has an open fault.

What is claimed is:

1. A drive system comprising:
an inverter circuit including switching circuits for multiple phases, each of the switching circuits including an upper arm and a lower arm connected in series, and each of the upper arm and the lower arm including multiple switching devices connected in parallel;
a motor driven by the inverter circuit to generate steering torque; and
a control device configured to control the inverter circuit, wherein
when detecting a fault in at least one of the multiple switching devices connected in parallel in any of the arms during use of a vehicle, the control device drives the remainder of the multiple switching devices in the arm in which the fault is detected, until the vehicle is brought to a prescribed vehicle non-use state, and
the control device restricts driving of the remainder of the multiple switching devices when the vehicle is brought to a vehicle use state from the prescribed vehicle non-use state.

2. The drive system according to claim 1, wherein restricting driving of the remainder of the multiple switching devices is any one of limiting a phase current in the remainder of the multiple switching devices to a value equal to lower than a prescribed upper limit value, and stopping driving of the remainder of the multiple switching devices to drive only the switching devices that are different in phase from the at least one switching device in which the fault is detected.

3. A control device configured to drive an inverter circuit including switching circuits for multiple phases, each of the switching circuits including an upper arm and a lower arm connected in series, and each of the upper arm and the lower arm including multiple switching devices connected in parallel, the control device comprising:
a fault determining unit configured to detect whether there is a fault in at least one of the multiple switching devices connected in parallel in any of the arms when a vehicle is in a use state; and
a drive control unit configured to drive, when a fault is detected in at least one of the switching devices by the fault determining unit, the remainder of the multiple switching devices in the arm in which the fault is detected, until the vehicle is brought to a prescribed vehicle non-use state, the drive control unit being configured to restrict driving of the remainder of the multiple switching devices when the vehicle is brought to a vehicle use state from the prescribed vehicle non-use state.

4. A control method of driving an inverter circuit disposed in a vehicle, the inverter circuit including switching circuits for multiple phases, each of the switching circuits including an upper arm and a lower arm connected in series, and each of the upper arm and the lower arm including multiple switching devices connected in parallel, the control method comprising:
detecting whether there is a fault in at least one of the multiple switching devices connected in parallel in any of the arms during use of the vehicle;
driving, when detecting a fault in at least one of the multiple switching devices, the remainder of the multiple switching devices in the arm in which the fault is detected, until the vehicle is brought to a prescribed vehicle non-use state; and
restricting driving of the remainder of the multiple switching devices when the vehicle is brought to a vehicle use state from the prescribed vehicle non-use state.

5. A drive unit comprising:
an inverter circuit including switching circuits for multiple phases, each of the switching circuits including an upper arm and a lower arm connected in series, and each of the upper arm and the lower arm including multiple switching devices connected in parallel; and
a control device configured to control the inverter circuit, wherein
when detecting a fault in at least one of the multiple switching devices connected in parallel in any of the arms during use of a vehicle, the control device drives the remainder of the multiple switching devices in the arm in which the fault is detected, until the vehicle is brought to a prescribed vehicle non-use state, and
the control device restricts driving of the remainder of the multiple switching devices when the vehicle is brought to a vehicle use state from the prescribed vehicle non-use state.
